(19) United States
(12) Patent Application Publication
(10) Pub. No.: US 2017/0201375 A1
(43) Pub. Date: Jul. 13, 2017

(54) SECURE CONTENT SHARING USING CONTENT CENTRIC APPROACH

(71) Applicant: Futurewei Technologies, Inc., Plano, TX (US)

(72) Inventors: Syed Obaid Amin, Santa Clara, CA (US); Ravishankar Ravindran, San Ramon, CA (US); Qingji Zheng, Pittsburgh, PA (US)

(21) Appl. No.: 14/991,303

(22) Filed: Jan. 8, 2016

(51) Int. Cl. H04L 9/32; H04L 29/06

(52) U.S. Cl. CPC H04L 9/3242; H04L 63/061

(57) ABSTRACT

A network enabled computer system includes a processor and a dual stack communication module to couple to a network. The dual stack communication module includes information centric network layers and a secure network connection layer, each coupled to an IP connection layer to couple to a network. A storage device is coupled to the processor to cause the processor to execute operations to route IP packets. The operations include establishing a secure connection using the secure connection layer, performing authentication via the secure connection using the secure connection layer, exchanging an encryption key via the secure connection using the secure connection layer, and transferring encrypted chunks of data using information centric network IP-content packets via the information centric network layers.

### FIELD OF THE INVENTION

The present disclosure is related to secure content sharing and in particular to secure content sharing using a content centric approach.

### BACKGROUND

There is a rapid growth in secure content sharing via public networks such as the Internet. Some estimates indicate that soon more than 60% of Internet traffic will be encrypted. One of the most prevalent methods of sharing content securely involves the use of per session keys using hypertext transfer protocol secure (HTTPS). Such methods provide end-to-end security, but are computationally expensive and disable caching in intermediate locations. Application centric methods, like some video sharing systems, work well for large data objects, like videos. Both methods utilize encrypted payloads which are not cached by intermediate middle boxes, resulting in potentially longer round trip times.

Internet Protocol (IP) forwarding is based on host-to-host communication utilizing host addresses. Communications are assumed to take place between two static end points. IP forwarding is sender-oriented, i.e., the receiver has no control of specifying the properties related to the information it desires, for example, content version, publisher, etc. Considering the growth in user driven multimedia content today, Content distribution network (CDN) has been developed to support content distribution. However, CDN is a technology overlaid over IP and is application specific.

As an alternative approach, information centric networking (ICN) addresses these issues by shifting the communication paradigm from a host-centric to a content-centric model. User requests are translated into packet data units that contain the name of the information sought with associated metadata. A router, upon receiving such a query, resolves it to itself if it has a cached copy of the data or forwards it along the direction where the content can be obtained.

### SUMMARY

A network enabled computer system includes a processor and a dual stack communication module to couple to a network. The dual stack communication module includes information centric network layers and a secure network connection layer, each coupled to an IP connection layer to couple to a network. A storage device is coupled to the processor to cause the processor to execute operations to route IP packets. The operations include establishing a secure connection using the secure connection layer, performing authentication via the secure connection using the secure connection layer, exchanging an encryption key via the secure connection using the secure connection layer, and transferring encrypted chunks of data using information centric network IP-content packets via the information centric network layers.

A method of securely providing data includes encrypting and publishing a data file, authenticating a user via a secure connection, providing an encryption key to the user via the secure connection, receiving a request from a client for the data file via an information centric network packet, and providing the data file to the client as encrypted chunks of data via information centric network IP-content packets.

A method implemented by a client computer includes obtaining a name of an encrypted data file, obtaining a location of the encrypted data file, establishing a secure connection with the location of the encrypted data file, providing authentication credentials via the secure connection, obtaining an encryption key via the secure connection, requesting the encrypted data file using an information centric network protocol packet, and receiving the encrypted data file via an information centric network protocol packet.

In further embodiments, a dual mode router includes processing circuitry and a storage device coupled to the processing circuitry. Forwarding rules are stored on the storage device and executable by the processing circuitry to route a received packet responsive to information in the packet by forwarding the received packets. An agent is executable by the processing circuitry to receive data packets, store non-duplicate data in the storage device, and to forward cached data from the storage device via an information centric network protocol.

A method routes IP packets via a dual mode router. The method includes parsing received IP packets to determine a destination and whether the IP packet is an IP protocol packet or an information centric network protocol packet, forwarding IP protocol packets to a server or a client responsive to the determined destination, forwarding information centric network protocol packets via an information centric network to the determined destination, caching encrypted data chunks contained in information centric network protocol packets, and providing the encrypted data chunks to clients requesting the encrypted data chunks via information centric network protocol packets.

A router includes a processor, a communication module to couple to a network, and a storage device coupled to the processor to cause the processor to execute operations to route IP packets. The operations include parsing received IP packets to determine a destination and whether the IP packet is an IP protocol packet or an information centric network protocol packet, forwarding IP protocol packets to a server or a client responsive to the determined destination, forwarding information centric network protocol packets via an information centric network connection to the determined destination, caching encrypted data chunks contained in information centric network protocol content packets, and providing the encrypted data chunks to clients requesting the encrypted data chunks via information centric network protocol interest packets.

### BRIEF DESCRIPTION OF THE DRAWINGS

FIG. 1 is a block diagram of an information centric secure content sharing architecture utilizing dual mode content aware routers according to an example embodiment.

FIG. 2 is a combined block and flowchart diagram of a dual mode content aware router according to an example embodiment.

FIG. 3 is a flowchart illustrating operations performed by a server in preparing content for distribution in a secure manner according to an example embodiment.

FIG. 4 is a network timing diagram illustrating operations performed in publishing and accessing data according to an example embodiment.

FIG. 5 is a flowchart illustrating alternative operations performed by a server in preparing content for distribution in a secure manner according to an example embodiment.

FIG. 6 is a network timing diagram illustrating operations performed in publishing and accessing data according to an example embodiment.

FIG. 7 is a block diagram illustrating circuitry for clients, servers, and dual mode content aware routers according to example embodiments.

### DETAILED DESCRIPTION

in the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

Information centric networks (ICN) have been used to transfer encrypted data from a producer server to users. Names of devices are exposed for use in the routing. Another type of network, a content distribution network (CDN) has also been developed to support content distribution. However, CDN is a technology overlaid over IP and is application specific.

Embodiments of the present subject matter use dual mode content aware routers (DCARs) that cache and route chunks of encrypted data. A secure channel is used by hosts of the data to authenticate users. An information centric network (ICN) approach is to transfer chunks of encrypted data from various intermediate nodes.

Three types of packets are utilized to effect the authentication and serving of encrypted data. IP packets are traditional IP packets. The second and third types of packets are IP packets that encapsulate ICN related packets that are identified as such by use of an IP packet type of service (ToS) bit. The ICN related packets include IP-Information (IP-I) packets that are used to request a content object from the network. The ToS bit is set to IP-I primitive, indicating that the packet is an ICN interest. IP-Content (IP-C) packets are IP packets containing a content object that can be cached. The ToS bit is set to IP-C primitive, indicating that the packet is an ICN content packet.

IP-C packets may be stored in a DCAR cache by indexing the IP-C packets to an application protocol layer's naming semantic. IP packets are received and forwarded by the DCARs according to well-known methods. IP-I and IP-C packets may be intercepted for application protocol level processing. Once intercepted, any type of service, such as content distribution or transformation, may be implemented.

A domain name server (DNS) may be used to obtain the IP address of a producer of the content, which can be useful for knowing the destination of the IP-I packets. A distributed computing enabled server and DCAR use the source address of an incoming IP-I packet as a destination of the IP-C packets. The destination is the default fall back if the content cannot be found in the cache of the DCAR. DCARs may support one, several, or all application level protocols, such as, for example, Ethernet, IP, hypertext transfer protocol (HTTP), HTTPS (HTTP Secure) and real-time transport protocol (RTP).

Client applications and server/producer applications utilize a dual stack that operates on both a secure channel and an ICN channel. The secure channel is used to authenticate a user/client and provide a key to decrypt data. The key may be a symmetric key or other type of key in various embodiments. The secure channel may also be used to provide manifest containing hashes of encrypted chunks of data such that the data need not be identified by a human readable name over a non-secure network. A human readable name is a name that generally has pronounceable characters or strings of characters that are easily recognizable by humans as opposed to strings of unpronounceable characters. The ICN channel is used to provide the data, utilizing DCAR caches of the data where available.

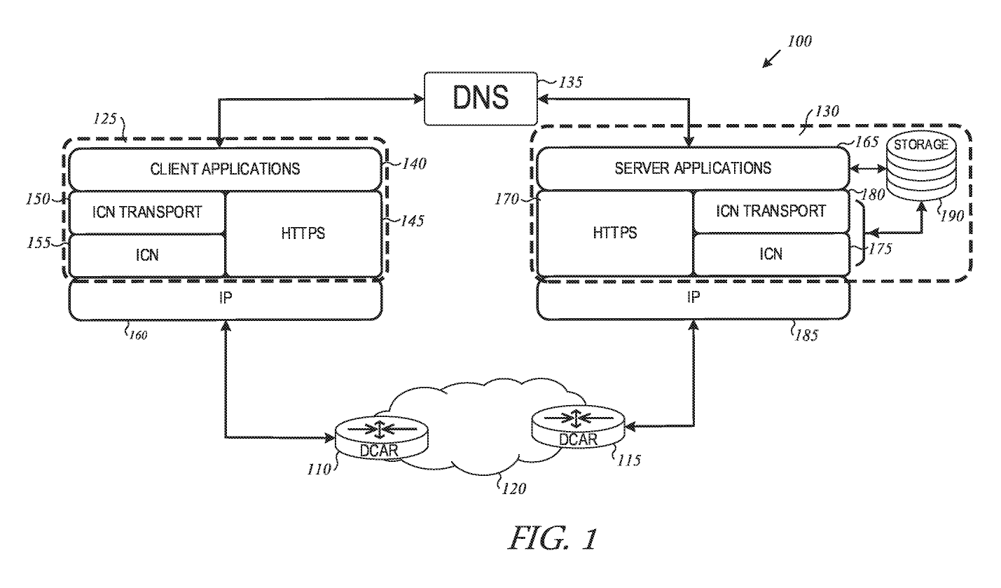

FIG. 1 is a block diagram of an information centric secure content sharing architecture 100 utilizing dual mode content aware routers indicated at 110 and 115 coupled to a public network 120, such as the Internet. Multiple client systems 125 and servers 130 may be coupled to the network 120 and utilize a naming service 135 for resolving physical addresses. The client systems 125 may have one or more client applications 140 that utilize a dual stack for efficient and secure content distribution. One side of the dual stack is an HTTPS stack 145 used for secure communications using IP flows. The other side of the dual stack comprises an ICN transport layer 150 and ICN layer 155, using file names to identify data to be transferred. An IP layer 160 provides a connection to an end host, possibly through one or more routers, such as DCAR 110.

The Server systems 130 contains one or more server applications 165, along with a similar dual stack comprising HTTPS stack 170, ICN transport 175 and ICN 180 layers, as well as IP layer 185. Server system 130 may also contain storage 190 which may be used to store data to be published and served to multiple clients via ICN transport layer 180 and ICN layer 175.

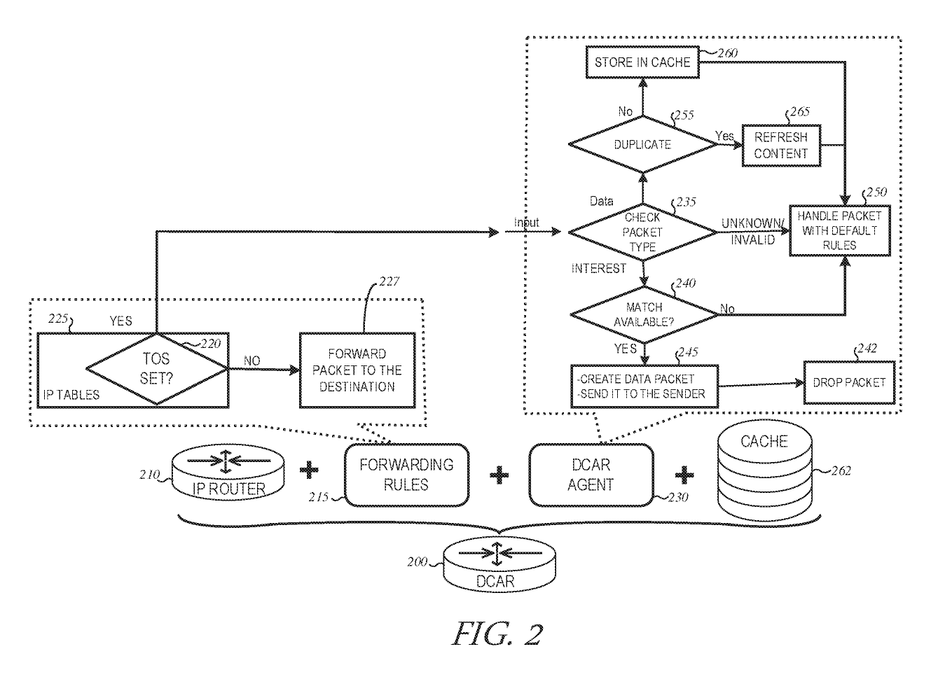

FIG. 2 is a combined block and flowchart diagram of a dual mode content aware router (DCAR) 200 DCAR 200 has the functions of an IP router 210 with forwarding rules 215. When a packet is received, a type of service (TOS) field is checked to see if it is set at 220, utilizing IP tables 225. The TOS field in one embodiment is an 8 bit field with two values used to indicate that the IP packet is an ICN primitive such as IP-I or IP-C. If TOS is not set, indicating that the IP packet does not contain an ICN IP primitive, the packet is simply forwarded at 227 to a destination in accordance with the IP protocol, operating just as a normal router would work.

If the IP packet does contain an ICN IP primitive, the packet is forwarded to a DCAR agent 230 for processing. At 235, the packet type is checked. If the packet type is an IP-I (IP Interest) packet, the agent determines if a match is available at 240. If a match is available, a data packet is created and sent to the sender at 245 and the packet is dropped at 242. The drop verdict is an indication that the DCAR 200 can handle the packet and the packet need not be further forwarded. If a match is not available, the packet may be handled with default rules at 250, such as default forwarding rules.

If at 235, the packet type is an IP-C (IP Content) packet, it is determined whether or not the packet is a duplicate at 255. If it is not a duplicate, the packet is stored at 260 in a cache 262, and the packet is handled with default forwarding rules at 250 to forward the packet. If at 255 it was determined that the packet is a duplicate, content is refreshed at 265 and may be managed in accordance with one of many available cache replacement policies. The packet is forwarded at 250. If at 235, an unknown or invalid packet type is detected, processing continues at 250 with acceptance and forwarding of the packet in accordance with default forwarding rules.

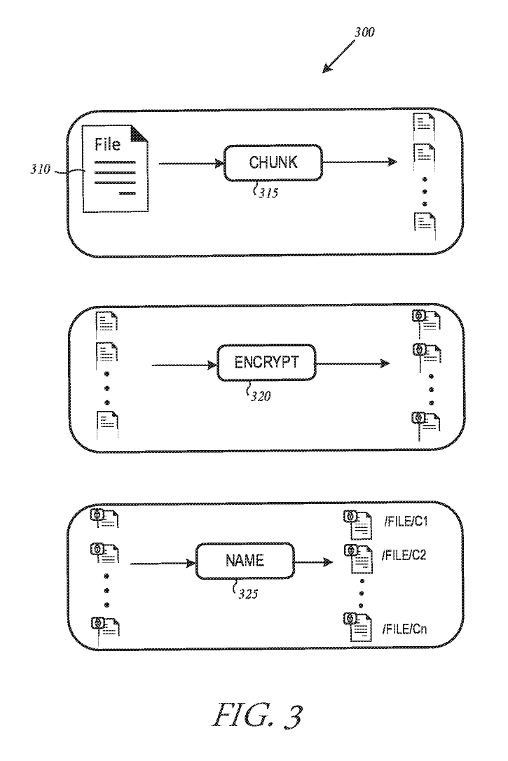

FIG. 3 is a flowchart illustrating operations 300 performed by a server in preparing content for distribution in a secure manner. The server may be a content server, such as a server that provides encrypted video, music, documents, and other data files to one or more clients. The data files may for example include sensitive documents to be shared with multiple users' client systems.

At 310, a file is received or otherwise identified as a file to be securely shared. The file is divided into one or more chunks at 315 suitable for sharing via the network. The size of the chunks may be selected consistent with IP packet size limitations and network interface limitations to avoid excess fragmentation in one embodiment. In one embodiment, a default chunk size is 8192 (8 bits by 1024 bytes). At 320, the chunks are encrypted, and named at 325 such that they can be accessed consistent with ICN protocols. Example named encrypted tiles are shown as /FILE/C1, /File/C2 . . . /FILE/Cn. The name in this example is generic: “/File/” with sequential numbers C1 through CN. In further embodiments, more descriptive names may be selected for a user's ease of use.

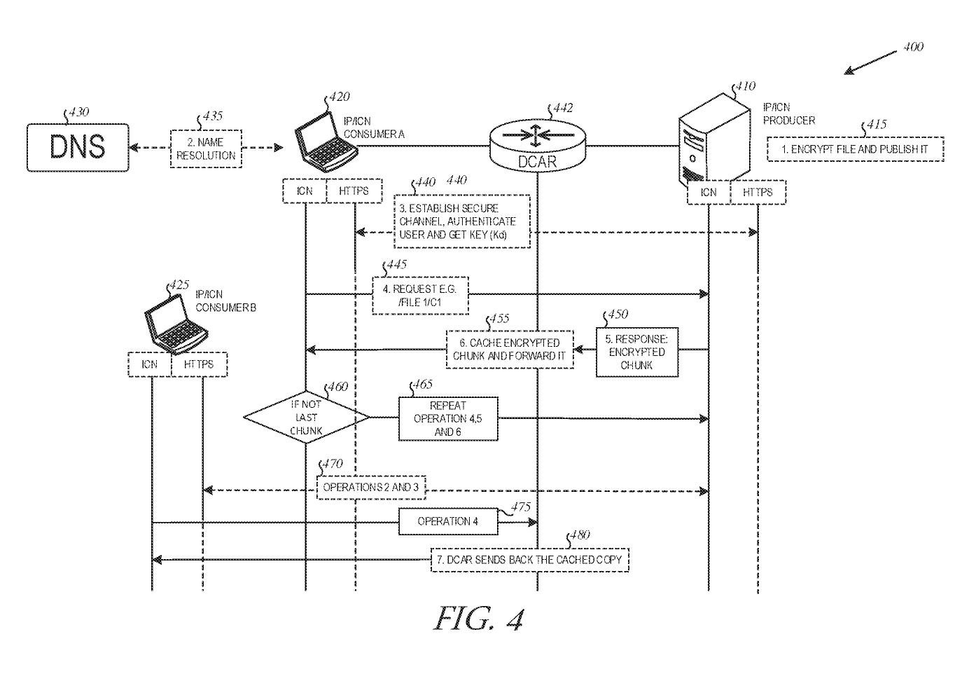

FIG. 4 is a network timing diagram illustrating operations performed in publishing and accessing data generally at 400. The operations are performed in this example by a server 410 which encrypts and publishes the data at 415. The server 410 may be referred to as an IP/ICN producer having a dual stack for communicating using IP and ICN network protocols. In one embodiment, publication occurs by sending, or otherwise making a name for the data available to one or more client computers indicated at 420 and 425. Publication may also occur by the server allowing clients to search for producers, connect, and search for available content. Note that publication in one example may include secure publication to a select group of users on client computers. Client computer 420 and 425 also have dual stacks for communicating using IP and ICN network protocols

In one embodiment, when client computer 420, being used by a user labeled as Consumer A, desires to obtain a copy of the published data, a request for the data may be generated utilizing known protocols resulting in a name resolution service, such as domain name server (DNS) 430 name resolution 435 to begin a secure channel as indicated at 440 using the HTTPS stack for example. The name resolution 435 is accomplished by the client computer 420 sending the name of the data to the name resolution service, such as DNS 430 and receiving the server's IP address in return. Note that a DCAR 442 may be used to perform common router functions such as routing information between the client and server so they can establish the secure channel. Via the secure channel, the user on the client computer 420 is authenticated, such as by use of a user ID and password, and a key for decrypting the data (K_{d}) is provided to the user as indicated at 440. The HTTPS connection may remain active as represented by the broken line after following authentication and provision of the key in some embodiments, or may be terminated.

The client computer 420 at this point may utilize the ICN stack and ICN IP primitives to request a file at 445 via an IP-I packet, /File1/C1 for example, which is a name of an encrypted chunk of the published data. For purposes of this example, it is assumed that this is the first time that the file has been requested, so the file may still reside only on the server 410 storage. At 450, the server 410 provides the encrypted chunk of the file in a response via an IP-C. packet, which is received by the DCAR 442, cached, and forwarded to the client 420. At 460, an operation is performed to determine if the received chunk is the last chunk of the requested data. If not, operations 445, 450 and 455 are performed until the last chunk has been received, meaning that the client computer has received every chunk of the requested data and every chunk was sent securely, as well as cached by the DCAR 442.

Client 425, being used by a user labeled as Consumer B, then decides to request the data. Client 425 performs the same operations as 435 and 440, establishing a secure connection to the server 410, providing authentication and receiving a key (K_{d}) to decrypt the received data, and then performs operation 475 to receive the encrypted chunks. Note that in this case, since the chunks were cached by DCAR 442, the request is processed by DCAR 442 by providing at 480 the encrypted chunks directly from DCAR 442 storage. The request is not forwarded to server 410. The shorter route utilized to provide the data results in a shorter round trip time (RTT) from the request to receiving the data.

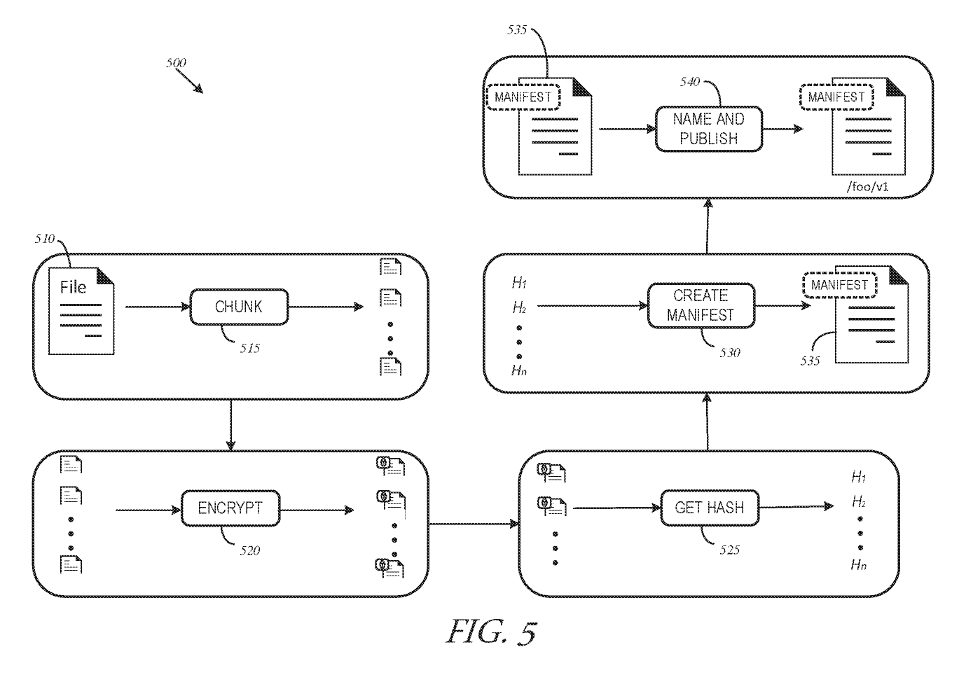

FIG. 5 is a flowchart illustrating alternative operations 500 performed by a server in preparing content for distribution in a secure manner. The server may be a content server, such as a server that provides encrypted video, music, documents, and other data files to one or more clients. The data files may for example include sensitive documents to be shared with multiple users' client systems.

At 510, a file is received or otherwise identified as a file to be securely shared. The file is divided into chunks at 515 suitable for sharing via the network. At 520, the chunks are encrypted. At 525, a hash is performed on each encrypted chunk, resulting in hashes indicated as H₁ through Hₙ. The hashes are used at 530 to create a manifest 530, which is basically a list of the hashes corresponding to the data that is to be published. A name for the manifest is created at 540, such as “/foo/v1/”, and published. The name may be an arbitrary name to help maintain security, or may be descriptive if desired.

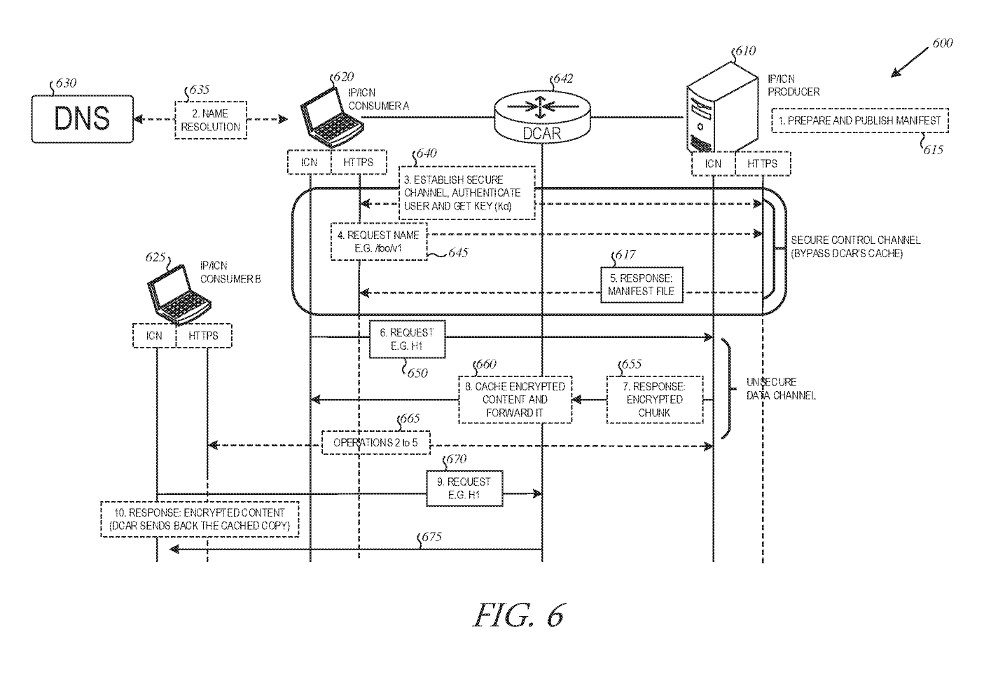

FIG. 6 is an example network timing diagram illustrating operations performed in publishing and accessing data generally at 600. The operations are performed in this example by a server 610 which encrypts and publishes a manifest at 615 that contains the hashes of the chunks of the data. Note that publication in this instance may simply include providing a name of the manifest file. The server 610 may be referred to as an IP/ICN producer having a dual stack for communicating using IP and ICN network protocols. In one embodiment, publication occurs by sending, or otherwise making a name for the manifest available to one or more client computers indicated at 620 and 625. Note that publication in this example may include secure publication to a select group of users on client computers. Client computers 620 and 625 also have dual stacks.

In one embodiment, when client computer 620, being used by a user labeled as Consumer B, desires to obtain a copy of the data corresponding to the published manifest, a request for the manifest may be generated utilizing IP protocols resulting in name resolution service such as DNS 630 name resolution 635 to obtain an IP address of the server. The address is used to begin a secure channel as indicated at 640 using HTTPS for example. Note that a DCAR 642 may be used to perform common router functions. Via the secure channel, the user on the client computer 620 is authenticated, such as by use of a user ID and password, and a key for decrypting the data is provided to the user. The HTTPS connection may remain active as represented by the broken line after following authentication and provision of the key in some embodiments, or may be terminated.

The client computer 620 at this point may utilize the ICN stack and ICN network to request the manifest at 645, /Foo/V1 for example. At 617, the server 610 responds via the secure channel with the manifest containing the hashes for the chunks of data. For purposes of this example, it is assumed that this is the first time that the data is being requested, so the chunks of data may still reside only on the server 610 storage.

At 650, the client 620 uses the ICN network to request the first encrypted data chunk by use of the hash H₁. The request is forwarded by the DCAR 642 to the server 610, which responds with the encrypted chunk at 655. The encrypted chunk is cached at DCAR 642, and forwarded 660 to the client 620. Operations 650, 655, and 660 are repeated until all the data is received.

Note that the secure connection utilizing for example HTTPS is used for authenticating the user, obtaining the key, and obtaining the manifest, while the actual data is transferred using ICN, an unsecured data channel.

The second client 625, being used by a user labeled as Consumer B, may also request the data in a similar manner, but since the data is cached by DCAR 642, the data will be forwarded via the DCAR cache, resulting in a shorter round trip time (RTT). The second client 625 also performs operations 635, 640, and 645 via the IP secure channel as indicated at 665, interacting with the server 610 to obtain the manifest in a secure manner, but then uses the hashes in the manifest to request 670 and obtain the data as indicated at 675.

The use of a secure channel with access control to exchange keys and optionally a manifest helps maintain confidentiality of the data. Integrity of the data is retained by using the ICN network for the data, as well as content authentication. The use of a manifest containing hashes further helps to maintain privacy. The ability to cash encrypted data at intermediate routers results in reduced backbone bandwidth consumption, reduced load on the producer and other content distributers, and reduced round trip time (RTT), providing a better user experience.

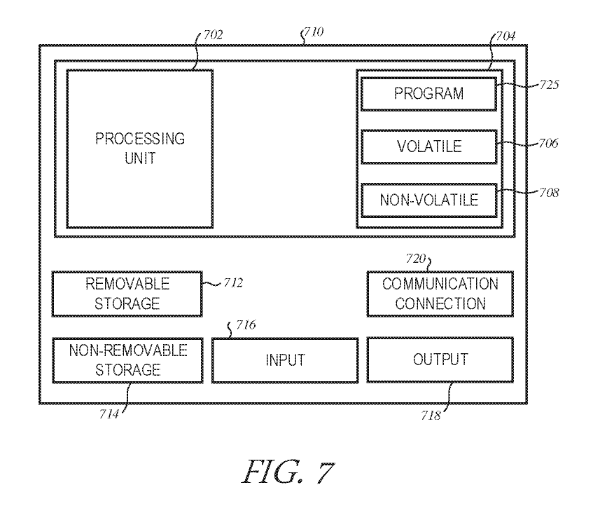

FIG. 7 is a block schematic diagram of a computer system 710 to implement methods according to example embodiments. All components need not be used in various embodiments. For example, the clients, servers, and DCARs may each use a different set of components, or in the case of servers for example, larger storage devices. Routers, for example, may have many more communication connections to communicate in parallel with multiple servers and clients.

One example computing device in the form of a computer 710 may include a processing unit 702, memory 704, removable storage 712, and non-removable storage 714. Although the example computing device is illustrated and described as computer 710, the computing device may be in different forms in different embodiments. For example, the computing device may instead be a smartphone, a tablet, smartwatch, or other computing device including the same or similar elements as illustrated and described with regard to FIG. 7. Devices, such as smartphones, tablets, and smartwatches, are generally collectively referred to as mobile devices or user equipment. Further, although the various data storage elements are illustrated as part of the computer 710, the storage may also or alternatively include cloud-based storage accessible via a network, such as the Internet or server based storage.

Memory 704 may include volatile memory 706 and non-volatile memory 708. Computer 710 may include—or have access to a computing environment that includes—a variety of computer-readable media, such as volatile memory 706 and non-volatile memory 714, removable storage 712. and non-removable storage 714. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 710 may include or have access to a computing environment that includes input 716, output 718, and a communication connection 720. Output 718 may include a display device, such as a touchscreen, that also may serve as an input device. The input 716 may include one or more of a touchscreen, touchpad, mouse, keyboard, camera, one or more device-specific buttons, one or more sensors integrated within or coupled via wired or wireless data connections to the computer 710, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 702 of the computer 710. A hard drive, CD-ROM, and RAM are some examples of articles including a non-transitory computer-readable medium such as a storage device. The terms computer-readable medium and storage device do not include carrier waves to the extent carrier waves are deemed too transitory. For example, a computer program 725 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 710 to provide generic access controls in a COM based computer network system having multiple users and servers. Storage can also include networked storage such as a storage area network (SAN) accessed via the communication connection 720.

### EXAMPLES

1. A method of securely providing data, the method comprising:
encrypting and publishing a data file;
authenticating a user via a secure connection;
providing an encryption key to the user via the secure connection;
receiving a request from a client for the data file via an information centric network packet; and
providing the data file to the client as encrypted chunks of data via information centric network IP-content packets.

2. The method of example 1 wherein encrypting and publishing a data file comprises:
encrypting multiple chunks of data comprising the data file;
naming each encrypted chunk of data; and
making names of each encrypted chunk of data searchable.

3. The method of example 2 wherein the request for the data file comprises the name of an encrypted chunk of data.

4. The method of any of examples 1-3 wherein encrypting and publishing a data file comprises:
encrypting multiple chunks of data comprising the data file;
creating a hash of each encrypted multiple chunk;
creating a manifest including the hash of each encrypted chunk;
naming the manifest; and
making the name of the manifest available to multiple clients.

5. The method of example 4 wherein the request for the data file comprises multiple requests, each request including a hash from the manifest.

6. The method of any of examples 4-5 and further comprising providing the manifest to a client via the secure connection.

7. The method of any of examples 1-6 wherein a dual stack including information centric network layers used for transferring information centric network packets and a secure network connection layer used for communicating via the secure connection.

8. A method implemented by a client computer, the method comprising:
obtaining a name of an encrypted data file;
obtaining a location of the encrypted data file;
establishing a secure connection with the location of the encrypted data file;
providing authentication credentials via the secure connection;
obtaining an encryption key via the secure connection;
requesting the encrypted data file using an information centric network protocol packet; and
receiving the encrypted data file via an information centric network protocol packet.

9. The method of example 8 wherein the encrypted data file contains multiple encrypted chunks, each chunk having a name.

10. The method of example 9 wherein the secure connection comprises an HTTPS connection.

11. The method of example 10 wherein secure connection packets are processed via an HTTPS stack and information centric network protocol packets are processed via an information centric network protocol stack.

12. The method of any of examples 8-11 wherein a dual stack including information centric network layers used for transferring information centric network packets and a secure network connection layer used for communicating via the secure connection.

13. A network enabled computer system comprising:
a processor;
a dual stack communication module to couple to a network, the dual stack communication module including information centric network layers and secure network connection layer, each coupled to an IP connection layer to couple to a network;
a storage device coupled to the processor to cause the processor to execute operations to route IP packets, the operations comprising:
   establishing a secure connection using the secure connection layer;
   performing authentication via the secure connection using the secure connection layer;
   exchanging an encryption key via the secure connection using the secure connection layer; and
   transferring encrypted chunks of data using information centric network IP-content packets via the information centric network layers.

14. The network enabled computer system of example 13 wherein the operations further comprise:
obtaining a name of an encrypted data file; and
requesting the encrypted data file by name using an IP-I packet.

15. The network enabled computer system of any of examples 13-14 wherein transferring encrypted chunks of data comprises:
receiving a request from a client for a data file via an information centric network packet; and
providing the data file to the client as encrypted chunks of data via information centric network IP-content packets.

16. The network enabled computer system of example 15 wherein the operations comprise:
encrypting and publishing a data file by:
   encrypting multiple chunks of data comprising the data file;
   naming each encrypted chunk of data; and
   making names of each encrypted chunk of data available to multiple clients.

17. The network enabled computer system of any of examples 15-16 wherein encrypting and publishing a data file comprises:
encrypting multiple chunks of data comprising the data file;
creating a hash of each encrypted multiple chunk;
creating a manifest including the hash of each encrypted chunk;
naming the manifest; and
making the name of the manifest available to multiple clients.

18. The network enabled computer system of example 17 wherein the request for the data file comprises multiple requests, each request including a hash from the manifest.

19. The network enabled computer system of example 18 wherein the manifest is provided to a client via the secure connection.

20. The network enabled computer system of any of examples 15-20 wherein the request for the data file comprises the name of an encrypted chunk of data.

21. A dual mode router comprising:
processing circuitry;
a storage device coupled to the processing circuitry;
forwarding rules stored on the storage device and executable by the processing circuitry to route a received packet responsive to information in the packet by forwarding the received packets; and
an agent executable by the processing circuitry to receive encrypted data packets, store non-duplicate encrypted data in the storage device, and to forward cached encrypted data from the storage device via an information centric network protocol.

22. The dual mode router of example 21 wherein the processing circuitry executes the forwarding rules to parse received packets, wherein the packets are IP packets, IP-interest packets, and IP-content packets with encrypted data.

23. The dual mode router of example 22 wherein the IP interest packets and IP content packets are information centric network protocol packets that are encapsulated in IP packets having a header with a type of service field identifying the type of packet.

24. The dual mode router of example 23 wherein IP content packets containing encrypted data are forwarded in accordance with forwarding rules.

25. The dual mode router of any of examples 23-24 wherein the agent is executed by the processing circuitry to:
check the packet type;
if the packet type is an IP-content packet containing encrypted data, store and forward data in the packet if the data is not duplicate data;
if the packet type is an IP-interest packet, determine if a match is available and if so, create a data packet and send the data packet to a sender of the received packet.

26. The dual mode router of example 25 wherein upon sending the data packet responsive to an IP-interest packet, the packet is dropped.

27. The dual mode router of any of examples 25-26 wherein a packet is handled with default forwarding rules responsive to a type of packet being found invalid or unknown.

28. The dual mode router of any of examples 23-27 wherein IP-content packets comprise a chunk of encrypted data.

29. The dual mode router of any of examples 23-28 wherein IP-interest packets contain a hash value identifying a chunk of encrypted data, wherein the hash value comprises a hash of the encrypted data chunk.

30. The dual mode router of any of examples 23-29 wherein IP-interest packets contain a name identifying a chunk of encrypted data.

31. A method of routing IP packets via a dual mode router, the method comprising:
parsing received IP packets to determine a destination and whether the IP packet is an IP protocol packet or an information centric network protocol packet;
forwarding IP protocol packets to a server or a client responsive to the determined destination;
forwarding information centric network protocol packets to the determined destination;
caching encrypted data chunks contained in information centric network protocol packets; and
providing the encrypted data chunks to clients requesting the encrypted data chunks via information centric network protocol packets.

32. The method of example 31 wherein the information content network packets comprises IP-interest packets and IP-content packets.

33. The method of example 32 wherein the IP interest packets and IP content packets are encapsulated in IP packets having a header with a type of service field identifying the type of packet.

34. The method of any of examples 32-33 wherein IP content packets are forwarded in accordance with forwarding rules.

35. The method of any of examples 32-34 wherein IP-content packets comprise a chunk of encrypted data.

36. The method of any of examples 32-35 wherein IP-interest packets contain a hash value identifying a chunk of encrypted data, wherein the hash value comprises a hash of the encrypted data chunk.

37. The method of any of examples 32-36 wherein IP-interest packets contain a name identifying a chunk of encrypted data.

38. A router comprising:
a processor;
communication module to couple to a network; and
a storage device coupled to the processor to cause the processor to execute operations to route IP packets, the operations comprising:
   parsing received IP packets to determine a destination and whether the IP packet is an IP protocol packet or an information centric network protocol packet;
   forwarding IP protocol packets to a server or a client responsive to the determined destination;
   forwarding information centric network protocol packets to the determined destination;
   caching encrypted data chunks contained in information centric network protocol content packets; and
   providing the encrypted data chunks to clients requesting the encrypted data chunks via information centric network protocol interest packets.

39. The router of example 38 wherein the processor wherein information centric network protocol content packets are forwarded in accordance with forwarding rules.

40. The router of any of examples 38-39 wherein the agent is executed by the processing circuitry to:
if the packet type is an information centric network protocol-content packet, forward the data if the data is duplicate, and if the data is not duplicate, cache and forward data in the packet; and
if the packet type is an information centric network protocol -interest packet, determine if a match is available and if so, create a data packet and send the data packet to a sender of the received packet, wherein information centric network protocol-content packets comprise a chunk of data.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method of securely providing data, the method comprising:
encrypting and publishing a data file;
authenticating a user via a secure connection;
providing an encryption key to the user via the secure connection;
receiving a request from a client for the data file via an information centric network packet; and
providing the data file to the client as encrypted chunks of data via information centric network IP-content packets.

2. The method of claim 1 wherein encrypting and publishing a data file comprises:
encrypting multiple chunks of data comprising the data file;
naming each encrypted chunk of data; and
making names of each encrypted chunk of data searchable.

3. The method of claim 2 wherein the request for the data file comprises the name of an encrypted chunk of data.

4. The method of claim 1 wherein encrypting and publishing a data file comprises:
encrypting multiple chunks of data comprising the data file;
creating a hash of each encrypted multiple chunk;
creating a manifest including the hash of each encrypted chunk;
naming the manifest; and
making the name of the manifest available to multiple clients.

5. The method of claim 4 wherein the request for the data file comprises multiple requests, each request including a hash from the manifest.

6. The method of claim 4 and further comprising providing the manifest to a client via the secure connection.

7. The method of claim 1 wherein a dual stack including information centric network layers used for transferring information centric network packets and a secure network connection layer used for communicating via the secure connection.

8. A method implemented by a client computer, the method comprising:
obtaining a name of an encrypted data
obtaining a location of the encrypted data file;
establishing a secure connection with the location of the encrypted data file;
providing authentication credentials via the secure connection;
obtaining an encryption key via the secure connection;
requesting the encrypted data file using an information centric network protocol packet; and
receiving the encrypted data file via an information centric network protocol packet.

9. The method of claim 8 wherein the encrypted data file contains multiple encrypted chunks, each chunk having a name.

10. The method of claim 9 wherein the secure connection comprises an HTTPS connection.

11. The method of claim 10 wherein secure connection packets are processed via an HTTPS stack and information centric network protocol packets are processed via an information centric network protocol stack.

12. The method of claim 8 wherein a dual stack including information centric network layers used for transferring information centric network packets and a secure network connection layer used for communicating via the secure connection.

13. A network enabled computer system comprising:
a processor;
a dual stack communication module to couple to a network, the dual stack communication module including information centric network layers and a secure network connection layer, each coupled to an IP connection layer to couple to a network;
a storage device coupled to the processor to cause the processor to execute operations to route IP packets, the operations comprising:
establishing a secure connection using the secure connection layer;
performing authentication via the secure connection using the secure connection layer;
exchanging an encryption via the secure connection using the secure connection layer; and
transferring encrypted chunks of data using information centric, network IP-content packets via the information centric network layers.

14. The network enabled computer system of claim 13 wherein the operations further comprise:
obtaining a name of an encrypted data file; and
requesting the encrypted data file by name using an IP-I packet.

15. The network enabled computer system of claim 13 wherein transferring encrypted chunks of data comprises:
receiving a request from a client for a data file via an information centric network packet; and
providing the data file to the client as encrypted chunks of data via information centric network IP-content packets.

16. The network enabled computer system of claim 15 wherein the operations comprise:
encrypting and publishing a data file by:
encrypting multiple chunks of data comprising the data file;
naming each encrypted chunk of data; and
making names of each encrypted chunk of data available to multiple clients.

17. The network enabled computer system of claim 15 wherein encrypting and publishing a data file comprises:
encrypting multiple chunks of data comprising the data file;
creating a hash of each encrypted multiple chunk;
creating a manifest including the hash of each encrypted chunk;
naming the manifest; and
making the name of the manifest available to multiple clients.

18. The network enabled computer system of claim 17 wherein the request for the data file comprises multiple requests, each request including a hash from the manifest.

19. The network enabled computer system of claim 18 wherein the manifest is provided to a client via the secure connection.

20. The network enabled computer system of claim 15 wherein the request for the data file comprises the name of an encrypted chunk of data.
